(19) United States
(12) Patent Application Publication
(10) Pub. No.: US 2026/0074392 A1
(43) Pub. Date: Mar. 12, 2026

(54) Battery Cell, System, Method for Producing a Battery Cell Assembly, and Battery Cell Assembly

(71) Applicant: Bayerische Motoren Werke Aktiengesellschaft, Muenchen (DE)

(72) Inventor: Philip KOTTER, Muenchen (DE)

(21) Appl. No.: 19/107,651

(22) PCT Filed: Aug. 25, 2023
(86) PCT No.: PCT/EP2023/073373

§ 371 Date: Feb. 28, 2025

(30) Foreign Application Priority Data
Sep. 1, 2022 (DE) 10 2022 122 105.9

(51) Int. Cl. H01M 50/559; H01M 10/04; H01M 50/503; H01M 50/516

(52) U.S. Cl. CPC H01M 50/559; H01M 10/0481; H01M 50/503; H01M 50/516

(57) ABSTRACT

Battery cells, including a connection point for electrically contacting the battery cell by a cell connector, wherein a surface of the connection point facing away from the battery cell has an inner section, an outer section, and a bending point at which the inner section merges into the outer section, and wherein the outer section of the surface descends with respect to the bending point, are provided. Systems including a battery cell and a cell connector corresponding to the battery cell, wherein the cell connector has a respective contact surface for electrical contacting of the battery cell, and the respective contact surface of the cell connector has a deformation that deviates from a plane in a predetermined manner, are further provided. Methods for producing a battery cell assembly are further provided.

Battery cell assemblies are further provided.

### BACKGROUND AND SUMMARY

A battery cell, a system comprising at least one such battery cell and a cell connector, a method for producing a battery cell assembly using the system, and a corresponding battery cell assembly are disclosed.

Cell connectors (busbars) and connection points (terminals) of battery cells usually have flat geometries in the contact region that are easy to manufacture. Cell connectors and connection points can, for example, be connected by laser welding using joints.

The production of a cell assembly often requires high contact forces on the cell connector against the connection point in order to produce the smallest possible welding gaps, taking into account the shape tolerances of the geometries in the contact region.

Deviations in the geometries in the contact region can result in (air) gaps between a surface of the connection point and a contact surface of the cell connector, which can lead to air inclusions in the weld seam (pores, blowholes and/or defects) that reduce its strength and electrical conductivity. In addition, due to the (air) gaps during welding, molten material can be thrown away from the welding location and can damage nearby components as “weld spatter”.

Furthermore, the position of the smallest possible welding gap varies greatly around a possibly predetermined welding location. For example, a first contact point of the cell connector usually occurs at the edge or an outer edge of the connection point, where welding is undesirable due to a lack of sufficient material at the connection point. Depending on the shape tolerance of the geometries in the contact region, one or more further contact point(s) can occur at any position, which cannot be taken into account when predetermining the welding location.

One problem to be solved is to specify a battery cell, a system comprising at least one such battery cell and a cell connector, as well as a method for producing a battery cell assembly using the system, with which comparatively small welding gaps can be produced with comparatively low contact pressure forces between the cell connector and the connection point.

These problems are solved by the subjects of the present disclosure. Advantageous embodiments, implementations and developments are further the subject of the present disclosure and may be selectively combined with one another.

According to a first aspect, a battery cell is provided which comprises a connection point for electrically contacting the battery cell by means of a cell connector.

Here and in the following, a battery cell is, for example, a secondary battery or an accumulator. A battery cell is therefore, for example, a single rechargeable storage element for electrical energy. In particular, the battery cell can be a round cell or prismatic cell with a wound or folded core. The battery cell has a lateral extent as well as a (central) longitudinal axis running obliquely or perpendicular thereto, which extends between an upper side and an underside of the battery cell.

The connection point forms one of the cell poles of the battery cell, for example on the upper side or underside of the battery cell. The connection point is intended for connection to a cell connector by means of joints. The connection point is to be understood in particular as a component or a component group or a region of a component or a component group of which the surface facing away from the battery cell is in direct contact with the cell connector during the intended operation of the battery cell.

The cell connector is for example a metallic sheet, for example made of copper or aluminum. The cell connector is intended in particular for the electrical contacting of a plurality of battery cells and is set up accordingly for connection by means of joints with a plurality of connection points. The cell connector has a corresponding contact surface for each connection point.

In an advantageous embodiment according to the first aspect, a surface of the connection point facing away from the battery cell has an inner section, an outer section and a bending point at which the inner section merges into the outer section, wherein the outer section of the surface descends with respect to the bending point.

The terms “inside” and “outside” are to be understood here relative to the lateral extent of the connection point, in other words, the inner section is closer to a center of the lateral extent of the connection point than the outer section or encloses it. The surface of the connection point facing away from the battery cell can be understood as a surface of the connection point with a normal vector which contains a component parallel to the longitudinal axis away from the inside of the cell.

For example, the connection point can have an outer section or a plurality of outer sections that are spatially separated from one another. The outer section(s) can spatially delimit one or more inner section(s). In this case, the bending point forms a transition from a respective inner section to or a separation from a respective outer section.

A bending point is understood here and in the following as a deliberately introduced curvature change in the surface of the connection point. For example, this is a lateral section of the connection point where a flat inner section merges into a sloping or curved outer section. The bending point forms a kind of edge or border on which a contact surface of the cell connector rests. The bending point serves in particular as a contact point or edge for the cell connector.

The fact that the outer section descends with respect to the bending point denotes a course of the surface inclined or curved in relation to the longitudinal axis in such a way that the bending point forms a most exposed point or edge of the connection point in relation to the longitudinal axis. The “descent” is characterized in particular by the fact that a circle with radius R2 inscribed in the concave inner geometry of a cell connector facing the connection point is larger than the radius R1 of a circle of the convex outer geometry of the connection point, wherein the exposed point lies on the circle line and determines its radius R1 and the connection point does not touch the circle or protrude beyond it at any other position. Depending on the size and design of the battery cell, this is the case, for example, from a height offset of 0.5 mm to 1 mm of an outermost point (=exposed point) of the inner section to an outermost point of the outer section.

In an advantageous way, such a connection point enables the production of a battery cell assembly with comparatively small welding gaps at a predetermined position. The bending point with a previously known position effectively shifts a first geometric contact point or a first geometric contact edge inwards in relation to the lateral extent of the connection point, where there is sufficient material of the connection point for a welding process. Statistically and procedurally, positional tolerances from cell connector to connection point can be better compensated for during production, and a position of the smallest welding gap can be (pre-)determined more reliably, so that a higher strength and conductivity of the connection between connection point and cell connector can be achieved with comparable contact forces. Alternatively or additionally, a reduction of the contact pressure forces in the manufacturing process is conceivable, taking into account the strength and conductivity to be achieved, so that, for example, with comparable strength and conductivity, requirements for material and manufacturing tolerances with regard to the contact pressure forces can be reduced and thus contribute to a cost-effective production of the battery cell assembly.

In an advantageous embodiment according to the first aspect, the inner section of the surface is arranged in a plane. In other words, the inner section of the surface is flat. The plane extends obliquely, in particular perpendicular to the longitudinal axis of the battery cell. In particular, the inner section of the surface, together with the bending point, forms a surface of the connection point that is most exposed in relation to the longitudinal axis.

In an advantageous embodiment according to the first aspect, the surface of the connection point facing away from the battery cell has at least two bending points that laterally delimit the inner section of the surface. For example, the bending points are arranged on at least two sides of a prismatic battery cell. In an advantageous manner, this results in a second and possibly third geometric contact point or geometric contact edge also at a predetermined, easily weldable position, especially if the bending points are symmetrical.

In an advantageous embodiment according to the first aspect, the bending point laterally encloses the inner section of the surface. In an exemplary embodiment, the bending point is circular and extends in a plane.

In an advantageous embodiment according to the first aspect, the bending point or bending points are formed in a plane. The plane extends obliquely, in particular perpendicular to the longitudinal axis of the battery cell and forms a region of the connection point that is most exposed in relation to the longitudinal axis. The bending point or bending points can, for example, be straight or curved in the plane.

In an advantageous embodiment according to the first aspect, the outer section of the surface is designed to descend in a straight manner or downward in a curved manner with respect to the bending point. A straight descent is to be understood in particular as a course of the surface at an angle to the longitudinal axis, by which, depending on the angle included with the longitudinal axis, a “sharp” edge is formed at the bending point, whereby a contact point or a contact edge of the cell connector can be predetermined particularly precisely. The outer section can be both the form of the outer surface of a truncated cone or a truncated pyramid. The term “descend in a curved manner” shall be understood to mean in particular a (convexly) curved course of the surface which, depending on the radius of curvature, forms a “soft” edge at the bending point, allowing the contact surface of the cell connector to be pressed on particularly without any gaps. The outer section can be designed in the form of the outer surface of a spherical layer.

In an advantageous embodiment according to the first aspect, the battery cell further comprises a throughplating which extends centrally through the connection point into the interior of the battery cell, wherein a side of the throughplating facing away from the battery cell does not protrude beyond the surface of the connection point facing away from the battery cell at the bending point. A throughplating is a connecting piece between the arrester tab inside the cell and the connection point for electrical contacting of the electrode layers of the battery cell. The throughplating can also be referred to as a rivet. The surface of the throughplating is particularly flat. For example, the surface of the throughplating and the inner section of the surface of the connection point can be arranged in one plane. Alternatively, the surface of the throughplating is lowered relative to the inner section of the surface of the connection point in relation to the longitudinal axis, so that it is ensured that contact points or contact edge(s) for the cell connector are formed by the bending point(s).

In an advantageous embodiment according to the first aspect, the connection point has a lateral extent of predetermined width B, and the outer section of the surface has a lateral extent between B/16 and B/4, in particular B/8. In an advantageous way, an effective inward displacement of the contact point(s) or contact edge(s) in relation to the lateral extent of the connection point is thus achieved and it is ensured that sufficient material of the connection point is available for a welding process, irrespective of the absolute size of the elements to be connected and the weld seam. Advantageously, if a throughplating is present, the contact point(s) or contact edge(s) is/are spaced from the throughplating in relation to the lateral extent of the connection point in such a way that the throughplating is not involved in the welding process. Depending on the size of the battery, the distance from the throughplating and the edge of the connection point can be approx. 2 to 3 mm, for example.

According to a second aspect, a system is disclosed comprising at least one battery cell according to the first aspect and a cell connector. For each battery cell, the cell connector a respective contact surface for making electrical contact with the corresponding battery cell. The respective contact surface of the cell connector has a deformation that deviates in a predetermined manner from a plane.

In an advantageous way, such a system enables the production of a battery cell assembly with comparatively small welding gaps at a predetermined position. Due to the bending point with previously known position in conjunction with the predeterminedly deformed contact surface of the cell connector, the contact point(s) or contact edge(s) can be reliably displaced inwards in relation to the lateral extent of the connection point, with the advantages described above. The above explanations regarding the first aspect apply equally to the second aspect and vice versa. The deformation may in particular be a curvature or rounding introduced, for example, by crowning.

In an advantageous embodiment according to the second aspect, the respective contact surface of the cell connector is concave.

In an advantageous embodiment according to the second aspect, the respective contact surface of the cell connector is shaped complementarily to the surface of the connection point of the corresponding battery cell. Complementarily means here and in the following that the contact surface has an inner region corresponding to the inner section of the surface of the connection point and an outer region corresponding to the outer section of the surface of the connection point, wherein at least the outer region has a shape that is adapted to the shape of the surface of the outer section of the surface of the connection point. For example, both the outer section of the surface of the connection point and the outer section of the contact surface of the cell connector can be curved. A radius of curvature of the outer section of the surface of the connection point is always smaller than a radius of curvature of the outer region of the contact surface of the cell connector, so that it is ensured that the bending point(s) always form(s) the contact point(s) or contact edge(s) for the cell connector.

In an advantageous embodiment according to the second aspect, a curvature of the outer section of the respective surface of the connection point facing away from the battery cell is larger than a curvature of the corresponding contact surface of the cell connector. In other words, the radius of curvature of the outer section of the surface of the connection point is smaller than the radius of curvature of the outer region of the contact surface of the cell connector.

According to a third aspect, a method for producing a battery cell assembly using the system according to the second aspect is disclosed. The method comprises the following steps, in particular in the order given:
providing and arranging the at least one battery cell such that the connection point forms an upper side of the corresponding battery cell;
providing and arranging the cell connector above the corresponding battery cell such that the respective contact surface of the cell connector covers the inner section of the connection point of the respective battery cell such that the cell connector rests on the bending point of the respective battery cell;
applying a force to the overlying cell connector so that the cell connector is pressed against the upper side; and
connecting the cell connector to the connection point in an integrally bonded manner at the bending point of the respective battery cell.

The above explanations regarding the second aspect apply equally to the third aspect and vice versa. The battery cells are arranged such that their longitudinal axes run parallel. It is conceivable here to provide a plurality of battery cells in one step and to place the cell connector in a subsequent step and then to connect it to the battery cells. Alternatively or additionally, it is also conceivable to provide a part of the battery cells intended for connection, for example, only a single battery cell, and to connect each one in turn to the cell connector.

In particular, the force is applied parallel to the longitudinal axis of the battery cells, for example in the center of each battery cell.

In an advantageous embodiment according to the third aspect, the cell connector is connected to the connection point by means of a laser welding process in the region of the bending point.

According to a fourth aspect, a battery cell assembly is disclosed. The battery cell assembly is produced by a method according to the third aspect. The above embodiments relating to the third aspect nevertheless apply to the fourth aspect.

Exemplary embodiments of the invention are explained in greater detail below with reference to the schematic drawings.

### BRIEF DESCRIPTION OF THE DRAWINGS

### In the Drawings:

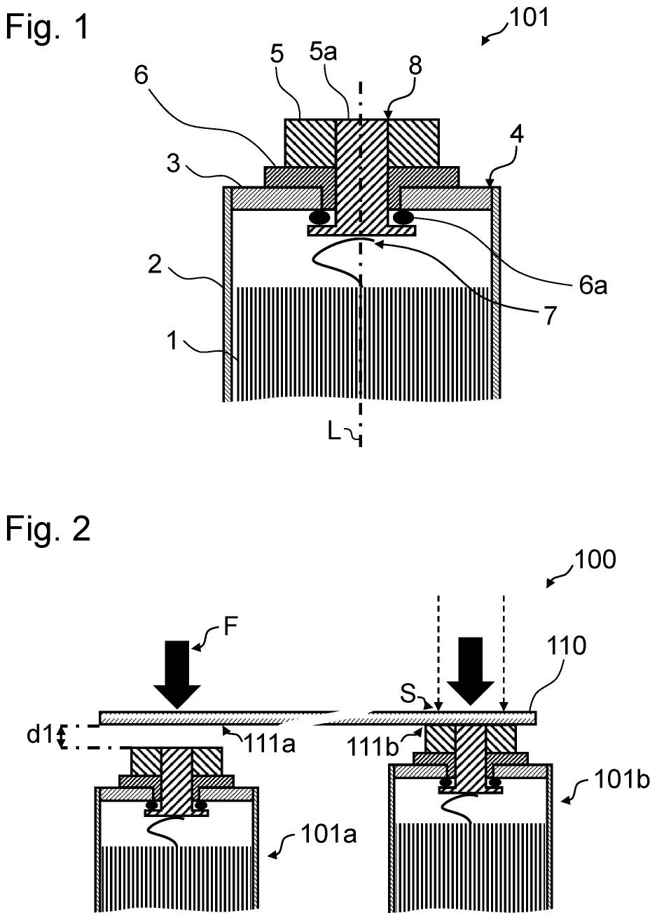

FIG. 1 shows a schematic structure of a prismatic battery cell-detail in the region of a cell pole;

FIG. 2 shows a system consisting of two prismatic battery cells according to FIG. 1 and a cell connector;

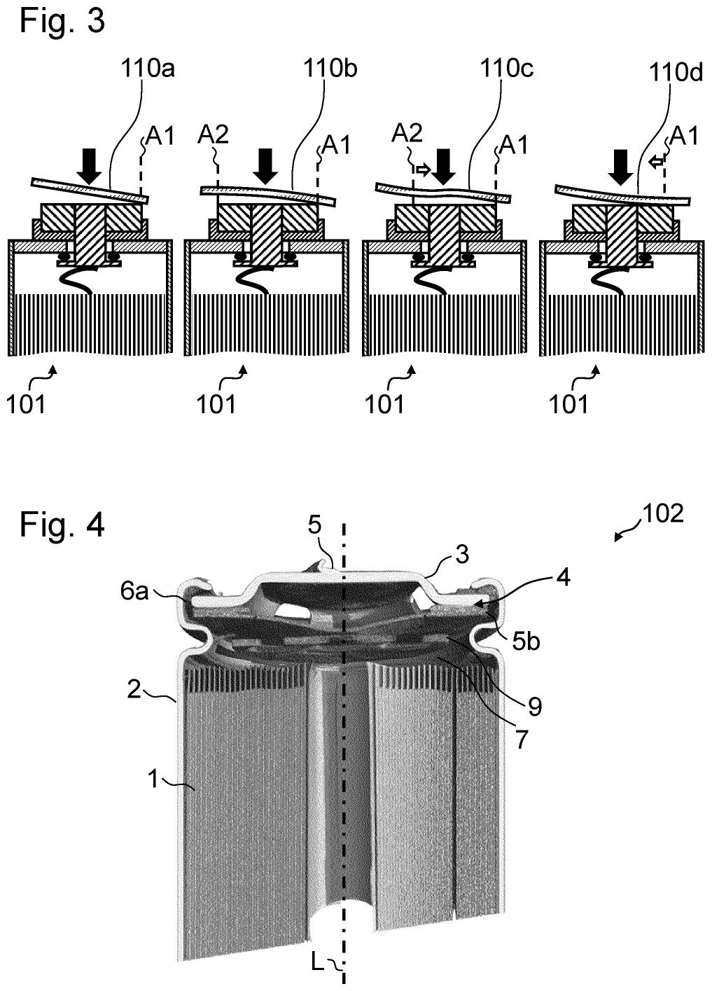

FIG. 3 shows contact points when connecting a prismatic battery cell according to FIG. 1 with a (from left to right) flat cell connector; concavely curved cell connector; irregularly curved cell connector; and convexly curved cell connector;

FIG. 4 shows a schematic structure of a round battery cell-detail in the region of a cell pole;

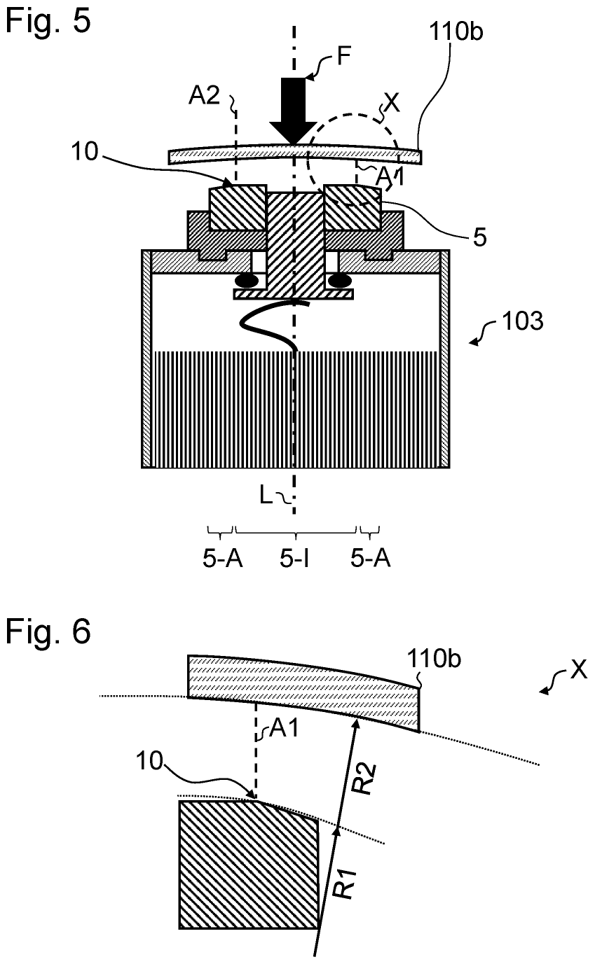

FIGS. 5 and 6 show a system of prismatic battery cell with bending point at connection point and curved cell connector (FIG. 5) and detailed view (FIG. 6);

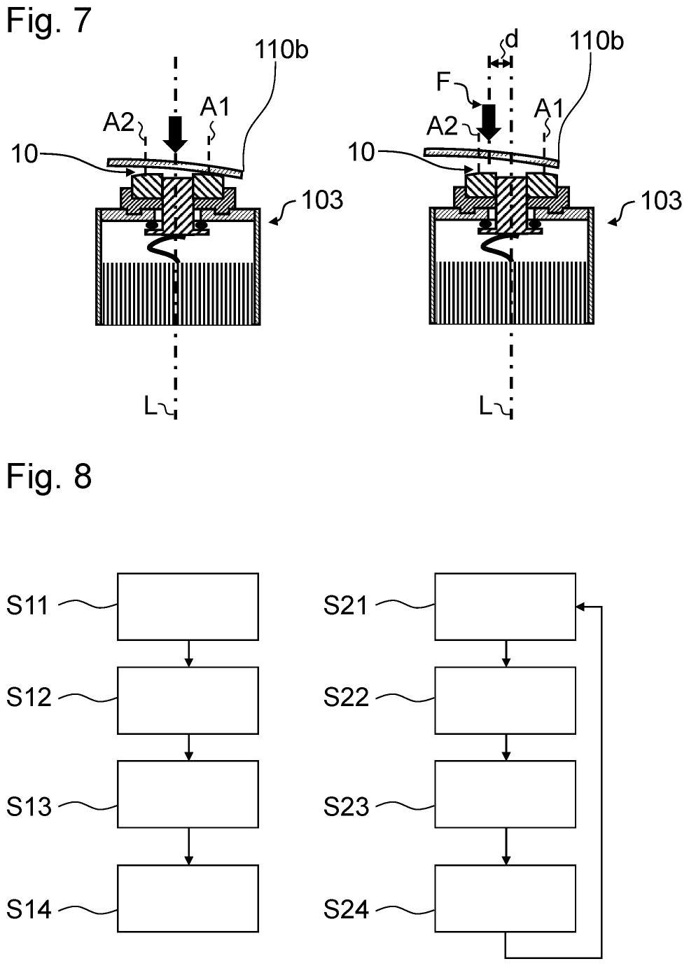

FIG. 7 shows the system according to FIG. 5 with position tolerances between cell connector and battery cell based on (from left to right) contact angle; and contact angle and position; and

FIG. 8 shows a flow chart for the production of a battery cell assembly using the system according to FIG. 5.

### DETAILED DESCRIPTION OF THE DRAWINGS

Elements of the same construction or function are marked with the same reference signs across all figures.

FIG. 1 shows an exemplary section of a prismatic battery cell 101. The battery cell 101 has a positive electrode and a negative electrode, each of which is formed by a plurality of electrode layers 1 arranged in a housing 2 of the battery cell 101. The housing 2 has a central longitudinal axis L and a lateral extent perpendicular to the longitudinal axis L. A cover 3 (cap plate) is arranged on an upper side of the housing 2 and is connected to the housing 2 by an ultrasonic or laser welding process. The corresponding welding point is highlighted with the reference sign 4.

The battery cell 101 also has a flat connection point 5 for making electrical contact with the battery cell 101, which serves as the cell terminal. The connection point 5 is arranged on a side of the cover 3 facing away from the interior of the housing and is electrically insulated from the housing 2 by an insulation 6 arranged between the cover 3 and the connection point 5.

A stamp-shaped throughplating 5a extends into the interior of the housing through the connection point 5 and electrically connects the connection point 5 to the electrode layers 1 via one or more arrester tabs 7 of the electrode layers 1. An electrically insulating seal 6a is also arranged between the throughplating 5a and the cover 3. The throughplating 5a is connected to the connection point 5 by an ultrasonic or laser welding process. The corresponding welding point is highlighted with the reference sign 8.

FIG. 2 shows an exemplary system 100 formed of two prismatic battery cells 101a, 101b as shown in FIG. 1 and a cell connector 110, which has contact surfaces 111a, 111b. The battery cells 101a, 101b have an offset d1 parallel to the longitudinal axes.

The connection points 5 are each rectangular in shape; a largely flat contact surface is formed on their upper side, subject to shape tolerances. The cell connector 110 is nevertheless flat subject to shape tolerances.

When forming a battery cell assembly, the system 100 is subjected to a force F (thick arrow) and the cell connector 110 is pressed against the corresponding connection point 5 and/or the throughplating 5a and then welded to the corresponding connection point 5 (dashed arrow). For this purpose, a position of a weld seam S can be predetermined, wherein the position of a respective contact point A1, A2 (see FIG. 3) or a corresponding minimum possible welding gap fluctuates significantly depending on the tolerance and/or shape of the cell connector 110, as explained in greater detail below with reference to FIG. 3.

FIG. 3 shows exemplary contact points A1, A2 when connecting a prismatic battery cell according to FIG. 1 with different cell connectors 110a-110d, wherein, for better clarity, the cell connectors 110a-110d are only shown in the region of a battery cell 101.

The cell connector 110a (1st from left) has a flat contact surface, but is positioned at an angle on the flat surface of the corresponding connection point, e.g., due to manufacturing tolerances. A first contact point A1 with a minimum possible welding gap is created at the edge of the connection point (indicated by the dotted line). There is little material available for the welding process at the edge of the connection point, which means that a welded joint at this position may potentially have insufficient strength and/or conductivity.

The cell connector 110b (2nd from left) has a concavely curved contact surface. A first contact point A1 with a minimum possible welding gap is again created at the edge of the connection point. For example, a second contact point A2 (also indicated by a dotted line) is also created at an opposite second edge of the connection point. The same problems arise as with cell connector 110a.

The cell connector 110c (3rd from left) has an irregularly curved contact surface. A first contact point A1 with a minimum possible welding gap is again formed at the edge of the connection point. For example, a second contact point A2 is also created at a position of the connection point that is indented with respect to the opposite second edge. With regard to the first contact point A1, the same problems arise as with cell connectors 110a and 110b. A welding process would in principle be possible at the second contact point A2, but due to the shape tolerances, the second contact point A2 is located at an undefined, relatively arbitrary position.

The cell connector 110d (4th from left) has a convex curved contact surface. A first contact point A1 with a minimum possible welding gap is created at a position indented with respect to the edge of the connection point. Analogously to cell connector 110c, a welding process would in principle be possible at the first contact point A1, but due to the shape tolerances, the first contact point A1 is located at an undefined, relatively arbitrary position.

It should also be noted that the behavior described above nevertheless usually leads to a third contact point in three dimensions for the mechanically determined bearing (not shown). The third contact point is created in the same way as above with the same disadvantages.

FIG. 4 shows an exemplary detail of a CT image of a cylindrical battery cell 102 (“round cell”). The battery cell 102 has a positive electrode and a negative electrode, each of which is formed by a plurality of electrode layers 1, for example, coiled electrode layers, which are arranged in a housing 2 of the battery cell 101. The housing 2 has a central longitudinal axis L and a lateral extent perpendicular to the longitudinal axis L. A cover 3 is arranged on an upper side of the housing 2 and connected to the housing 2 by an ultrasonic or laser welding process. The corresponding welding point is highlighted with the reference sign 4.

The battery cell 102 also has a flat connection point 5 for making electrical contact with the battery cell 102, which serves as a cell pole and is usually in the form of a disk. The connection point 5 is formed, for example, centrally by material of the cover 3 and is electrically separated from the housing 2 by an electrically insulating seal 6a arranged between the cover 3 and the housing 2.

A current collector 5b is arranged below the cover 3 and electrically connects the connection point 5 via a disk 9 and one or more arrester tabs 7 (not shown in FIG. 4) of the electrode layers 1 to the electrode layers 1. Depending on the contact, the disk 9 can be an anode or cathode disk, which connects accordingly to an anode or cathode of the electrode layers 1 via the arrester tab(s) 7. The respective other, i.e., cathode or anode disk, is arranged, for example, on an underside of the battery cell 102 (not shown in greater detail). The current collector 5b is connected to the cover 3 by an ultrasonic or laser welding process. The corresponding welding point is highlighted with the reference sign 8.

Correspondingly to the contact points A1, A2 shown in FIG. 3 for the cuboid connection point 5, a comparable problem arises for the disk-like connection point 5 of the round cell with regard to the strength or conductivity and reproducibility of the welds.

As shown in FIG. 5, a battery cell 103 with a convex or bent surface of the connection point 5 is proposed below. As shown, the battery cell 103 is for example, a prismatic battery cell with a connection point 5 of rectangular, e.g. square lateral extent similar to the battery cell 101 according to FIG. 1, or a cylindrical battery cell with a connection point 5 of circular lateral extent similar to the battery cell 102 according to FIG. 4. The battery cell 103 differs in that only an inner section 5-I of a surface of the connection point 5 facing away from the battery cell 103 is flat with respect to the central longitudinal axis L, while one or more outer section(s) 5-A with respect to the central longitudinal axis L descends with respect to the plane, so that a bending point 10 is formed at the transition from the outer to the inner section. An edge of this kind can contribute to the reproducible generation of a minimal welding gap at a defined position, as explained in greater detail below: For example, a first geometric contact point A1 can be moved inwards, towards the central longitudinal axis L, to the position of the bending point 10, so that it is ensured that sufficient material of the connection point 5 is available for a welding process at this point. If the bending point 10 is symmetrical, a second/third contact point A2 is also created at a defined and weldable point. The descending surface in the outer section 5-A can be straight or curved. In particular, it is possible to shape the contact surface of the cell connector 110 to complement the descending surface in the outer section 5-A, for example by curving it.

As can be from the enlarged detail X in FIG. 6, the curvature of the descending surface in the outer section 5-A must always be larger than that of the cell connector 110, in other words, the corresponding radius of curvature R1 of the descending surface in the outer section 5-A must always be smaller than the radius of curvature R2 of the contact surface, so it is ensured that a minimal gap geometry is always created at the bending point 10. If the design is symmetrical, it can also be ensured in three dimensions that a third contact point is located along the corresponding bending point and that a comparatively small gap is created overall. In an advantageous way, this can contribute to a statistically and procedurally safer or better weldable positioning of the minimum possible welding gap and thus higher strength and conductivity of the joint.

As shown in FIG. 7, position tolerances between cell connector 110 and connection point 5 as well as manufacturing tolerances can be better compensated. Even if the cell connector 110b is applied at an angle (left) or offset (offset d, right), the contact points A1, A2 are formed at a predetermined, indented position with the advantages described above.

The flowchart in FIG. 8 shows method steps for producing a cell assembly using a plurality of proposed battery cells 103 and the convexly curved cell connector 110b.

First (S11, left), the battery cells 103 are provided and arranged such that the connection points 5 to be connected are oriented parallel to each other.

The cell connector 110b is then (S12, left) placed on the connection points 5 such that the cell connector 110b rests on the bending points 10 of the battery cells 103.

The cell connector 110b is then pressed onto the connection points 5 (S13, left) and welded to the connection point 5 at predetermined positions corresponding to the bending points 10 of the battery cells 103 (S14, left). Alternatively, only some of the battery cells 103 to be connected are provided in step S11 (S21, right) and steps S11 to S14 are iteratively run through for some of the battery cells 103 to be connected (S21 to S24, right).

### LIST OF REFERENCE SIGNS

1 electrode layers
2 housing
3 cover
4 welding point
5 connection point
5a throughplating
5b current collector
6 insulation
6a seal
7 arrester tab
8 weld seam
9 disk
10 bending point
100 system 101-103, 101a, 101b battery cell
110, 110a-d cell connector
F force
L longitudinal axis
S weld seam
A1, A2 contact point
5-A, 5-I sections
R1, R2 radii of curvature
X enlarged detail
d offset
S11-S24 method steps

1-15. (canceled)

16. A battery cell, comprising
a connection point for electrically contacting the battery cell by a cell connector;
wherein a surface of the connection point facing away from the battery cell has an inner section, an outer section, and a bending point at which the inner section merges into the outer section; and
wherein the outer section of the surface descends with respect to the bending point.

17. The battery cell according to claim 16, wherein the inner section of the surface is arranged in a plane.

18. The battery cell according to claim 16, wherein the surface of the connection point facing away from the battery cell has at least two bending points that laterally delimit the inner section of the surface.

19. The battery cell according to claim 16, wherein the bending point laterally surrounds the inner section of the surface.

20. The battery cell according to claim 16, wherein the bending point extends in one plane.

21. The battery cell according to claim 16, wherein a plurality of bending points extend in one plane.

22. The battery cell according to claim 16, wherein the outer section of the surface descends in a straight or curved manner with respect to the bending point.

23. The battery cell according to claim 16, further comprising a throughplating that extends centrally through the connection point into the interior of the battery cell;
wherein a side of the throughplating facing away from the battery cell does not project beyond the surface of the connection point facing away from the battery cell at the bending point.

24. The battery cell according to claim 16, wherein the connection point has a lateral extent of predetermined width B, and the outer section of the surface has a lateral extent between B/16 and B/4.

25. The battery cell according to claim 16, wherein the connection point has a lateral extent of predetermined width B, and the outer section of the surface has a lateral extent of B/8.

26. A system, comprising:
a battery cell according to claim 16; and
a cell connector corresponding to the battery cell;
wherein the cell connector has a respective contact surface for electrical contacting of the battery cell, and the respective contact surface of the cell connector has a deformation that deviates from a plane in a predetermined manner.

27. The system according to claim 26, comprising:
a plurality of battery cells;
a plurality of cell connectors, each of the plurality of cell connectors having a respective contact surface for electrical contacting of a corresponding battery cell of the plurality of battery cells; and
wherein the respective contact surface of each of the plurality of cell connectors has a deformation that deviates from a plane in a predetermined manner.

28. The system according to claim 26, wherein the respective contact surface of the cell connector is concave.

29. The system according to claim 26, wherein the respective contact surface of the cell connector is shaped complementarily to the surface of the connection point of the battery cell.

30. The system according to claim 26, wherein a curvature of the outer section of the respective contact surface of the connection point facing away from the battery cell is larger than a curvature of the respective contact surface.

31. A method for producing a battery cell assembly, comprising:
arranging a battery cell such that a connection point forms an upper side of the battery cell, the connection point electrically contacting the battery cell by a cell connector;
arranging the cell connector above the battery cell such that the respective contact surface of the cell connector covers the inner section of the connection point of the battery cell such that the cell connector rests on a bending point of the battery cell, wherein the bending point is at which an inner section of a surface of the connection point facing away from the battery cell merges into an outer section of the surface;
applying a force to the cell connector such that the cell connector is pressed against an upper side of the battery cell; and
connecting the cell connector to the connection point in an integrally bonded manner at the bending point of the respective battery cell.

32. The method according to claim 31, wherein the connecting is by laser welding in the region of the bending point.

33. The method according to claim 31, wherein the applying is parallel to a longitudinal axis of the battery cell.

34. A battery cell assembly produced by the method according to claim 31.

35. A battery cell assembly produced by the method according to claim 32.
